(19) United States
(12) Patent Application Publication
(10) Pub. No.: US 2002/0181507 A1
(43) Pub. Date: Dec. 5, 2002

(54) System and method of incremental parsing

(76) Inventor: Clifton T. Jones, Garner, NC (US)

Correspondence Address: Pillsbury Winthrop LLP, Intellectual Property Group, 50 Fremont Street, San Francisco, CA, 94105, US

(21) Appl. No.: 09/872,821

(22) Filed: Jun. 1, 2001

(51) Int. Cl. H04J 3/24

(52) U.S. Cl. 370/474; 370/389

(57) ABSTRACT

A method of parsing data messages incrementally includes executing an initial parse of an incoming data packet and determining whether additional parsing is required or requested. An additional parse is selectively executed only if required by the data message recipient. Additionally, a system and a protocol stack employing a method of incremental parsing are disclosed.

### FIELD OF THE INVENTION

Aspects of the present invention relate generally to processing data messages, and more particularly to a system and method of incrementally parsing data packets transmitted across a communications network.

### BRIEF DESCRIPTION OF THE DRAWINGS

FIG. 1 is a simplified high-level block diagram illustrating a data communication network environment in which a system and method of incremental parsing may be employed.

FIG. 2 is a simplified block diagram illustrating the general operation of one embodiment of a system and method of incremental parsing.

FIG. 3A is a simplified flow diagram illustrating the general operation of one embodiment of a system and method of incremental parsing.

FIG. 3B is a simplified flow diagram illustrating the general operation of one embodiment of an initial parse.

FIG. 4A is a simplified high-level block diagram illustrating one embodiment of the results obtained by an initial parse.

FIG. 4B is a simplified high-level block diagram illustrating one embodiment of the results obtained by an additional parse.

FIG. 5 is a sequence diagram illustrating the general operational flow of one embodiment of a system and method of incremental parsing.

FIG. 6 is a simplified high-level block diagram illustrating one embodiment of a system implementing an incremental parsing strategy.

### DETAILED DESCRIPTION

Embodiments of the present invention overcome various shortcomings of conventional technology, providing a system and method of parsing data packets incrementally.

In accordance with one aspect of the present invention, a protocol stack may execute an initial parse, for instance, to determine that a complete message has been received and that the basic message structure is intact. Following the initial parse, additional parsing of header information or other data content may be selectively executed only when required.

The foregoing and other attendant features and advantages of the various embodiments of the present invention will be apparent upon examination of the following detailed description thereof in conjunction with the accompanying drawings.

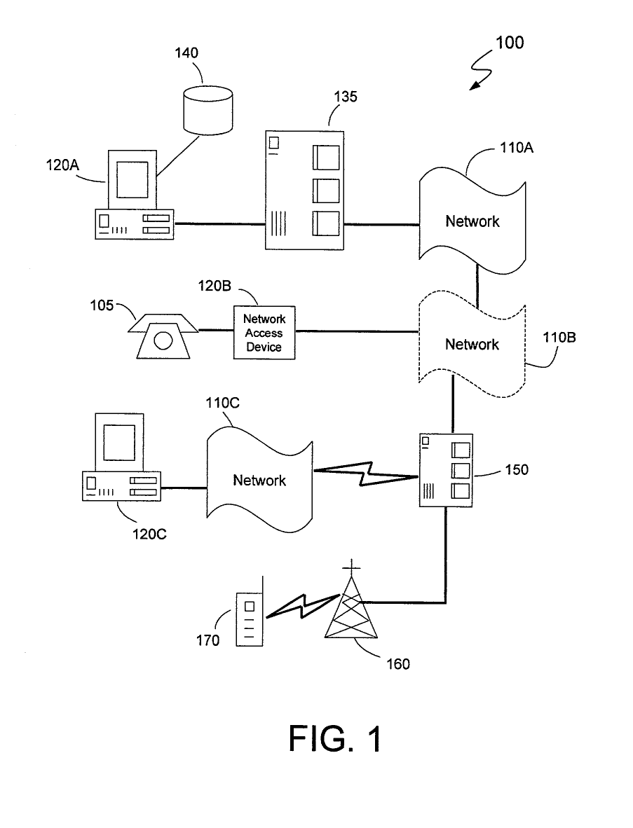

Turning now to the drawings, FIG. 1 is a simplified high-level block diagram illustrating a data communication network environment in which a system and method of incremental parsing may be employed. A network system 100 may be configured to facilitate packet-switched data transmission of text, audio, video, Voice over Internet Protocol (VoIP), multimedia, and other data formats known in the art. System 100 may operate in accordance with various networking protocols, such as Transmission Control Protocol (TCP), Internet Protocol (IP), Hypertext Transfer Protocol (HTTP), Simple Mail Transfer Protocol (SMTP), Asynchronous Transfer Mode (ATM), Real-time Transport Protocol (RTP), Real-time Streaming Protocol (RTSP), Session Announcement Protocol (SAP), Session Description Protocol (SDP), and Session Initiation Protocol (SIP). Those of skill in the art will appreciate that a method and system of incremental parsing may be employed advantageously in conjunction with numerous other protocols accommodating packet-switched data transmission, such as H.323 and MGC3, for example.

Network access devices 120A-120C may be connected via one or more communications networks 110A-110C enabling two-way point-to-point, point-to-multipoint, or multipoint-to-multipoint data transfer between and among network access devices 120A-120C. Additionally, network access devices 120A-120C may be coupled with peripheral devices such as, inter alia, a telephone 105 or wireless telephone 170. Those of skill in the art will appreciate that network access devices 120A-120C and any attendant peripheral devices may be coupled via one or more networks 110A-110C as illustrated in FIG. 1.

In some embodiments, for instance, network access device 120A-120C may be personal desktop or laptop computers, workstations, personal digital assistants (PDAs), personal communications systems (PCSs), wireless telephones, or other network-enabled devices. The scope of the present disclosure is not limited by the form or constitution of network access devices 120A-120C; any apparatus known in the art which is capable of data communication on networks 110A-110C is within the scope and contemplation of the inventive system and method.

Each individual network 110A-110C may also include other networkable devices known in the art in addition to one or more of the following, for example: storage media 140; application server 135; telephone server 150; and wireless telephone base station 160. It is well understood in the art that any number or variety of computer networkable devices or components may be coupled to networks 110A-110C without inventive faculty. Examples of other devices include, but are not limited to, the following: servers; computers; workstations; terminals; input devices; output devices; printers; plotters; routers; bridges; cameras; sensors; or any other networkable device known in the art.

A network 110A-110C may be any communication network known in the art, including the Internet, a local area network (LAN), a wide area network (WAN), a virtual private network (VPN), or any similarly operating system linking network access devices 120A-120C and similarly capable equipment. Further, networks 110A-110C may be configured in accordance with any topology known in the art such as, for example, star, ring, bus, or any combination thereof.

Application server 135 may be connected to network 10A which supports receipt and transmission of data packets. Telephone network server 150 may be configured to allow two-way data communication between different networks, such as networks 110B and 110C as depicted in FIG. 1. Additionally or alternatively, telephone network server 150 may communicate with a packet-switched telephone network (PSTN), plain old telephone service (POTS) network, Integrated Services Digital Network (ISDN), or any other telephone network. As illustrated in FIG. 1, telephone network server 150 may be coupled to wireless base station 160, which supports two-way communication between telephone network server 150 and wireless telephone 170.

During transmission across a packet-switched network system such as depicted in FIG. 1, data packets are parsed upon receipt at each proxy and at the destination endpoint device, since address and routing information are required in order to direct the data packets to the correct destination. For example, electronic mail (e-mail) comprising data packets may be transmitted from network access device 120C and addressed to a recipient desiring to receive the e-mail at network access device 120A. In this instance, given the exemplary arrangement illustrated in FIG. 1, the e-mail data packets will be received, parsed for addressing data, reassembled into proper format for the network protocol, and subsequently transmitted by at least the following network components: one or more servers in network 110C; telephone network server 150; one or more servers in each of networks 110B and 110A; and application server 135. At the destination address, the data packets will be parsed upon receipt at network access device 120A.

The cumulative effect of excessive processing at each of the proxies in a packet-switched network results in transmission delay. Additionally, unnecessary processing of header information and other data is an inefficient use of system resources.

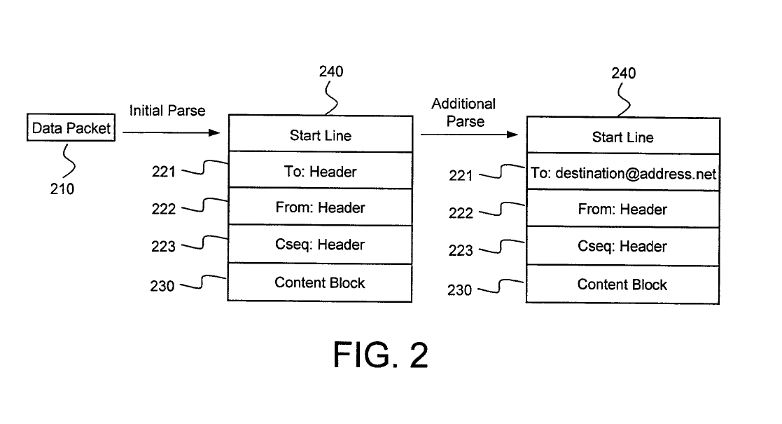

FIG. 2 is a simplified block diagram illustrating the general operation of one embodiment of a system and method of incremental parsing. Upon receipt at each proxy as described in the example above, the protocol stack may execute an initial parse of data packet 210. In the initial parse, data packet 210 may be parsed only to the extent required to determine its structure and integrity, for example. The initial parse may be executed optimistically, i.e. in order to increase overall message throughput.

An initial parse of a Session Initiation Protocol (SIP) packet start line 240, for instance, may be sufficient to determine that a complete SIP message has been received and that the basic message structure is intact. Packet start line 240 may also provide information sufficient to classify the message as a request or a response. As illustrated in FIG. 2, the initial parse may identify and separate headers 221-223 without expending system resources to parse specific content. Further, the content block 230 of data packet 210 may be identified, but not parsed in detail.

In accordance with this embodiment, the structure and integrity of data packet 210 may be ascertained through the initial parse which requires low system overhead. Following the initial parse, additional parsing of header information or other data content may be selectively executed only when required. An additional parse may be necessary, for example, in order for the application layer of the protocol stack to execute certain operations or for the transport layer to route data packet 210 to the proper destination.

If an application requires further parsing, for example, a request may invoke additional parsing operations. Responsive to a request from the application, for example, one or more headers may be parsed out into a structure that contains the full breakdown of the particular field requested. In the exemplary additional parse illustrated in FIG. 2, parsing of the ‘To:’ header 221 has been requested. In response, the protocol stack may selectively execute an additional parse of the information in header 221 to ascertain routing information for data packet 210 (in this example: destination@address.net).

Those of skill in the art will appreciate that any parsed components of data packet 210 must be reassembled for transmission. A system and method of incremental parsing operative in accordance with the present invention may reconstruct, or re-encode, an entire data packet or message from a combination of unparsed packet components (such as headers 222, 223 and content block 230) and fully parsed packet components (such as start line 240 and ‘To:’ header 221).

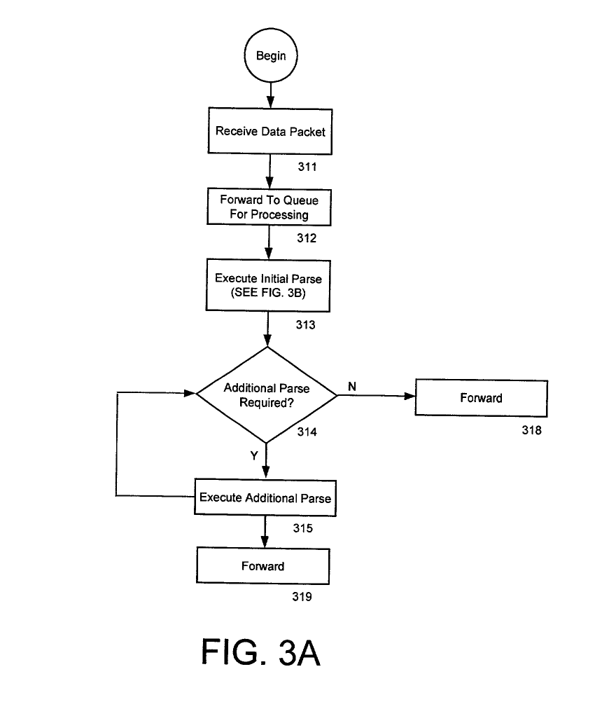

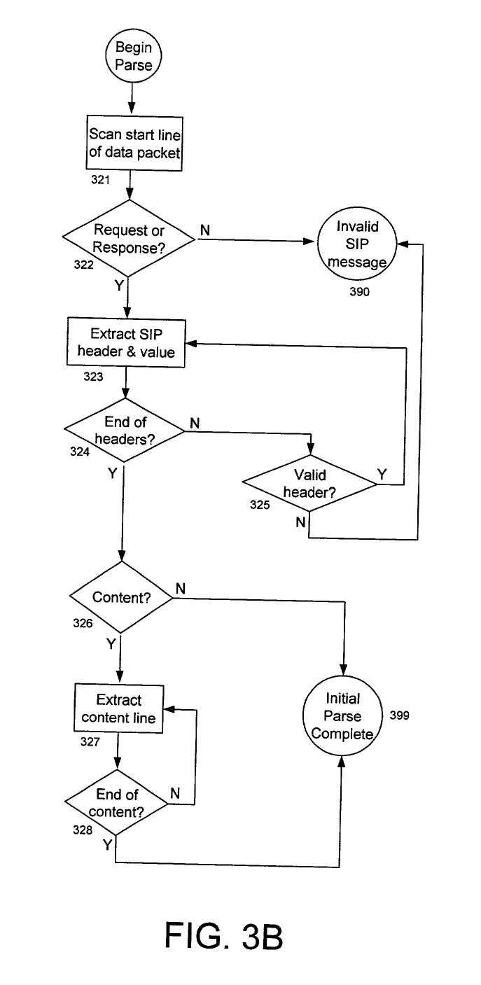

FIG. 3A is a simplified flow diagram illustrating the general operation of one embodiment of a system and method of incremental parsing. An incoming data packet may be received and forwarded to a queue for processing (at blocks 311 and 312, respectively) as is generally known in the art. An initial parse may then be executed as shown at block 313; this initial parse may correspond substantially to that described above with reference to FIG. 2 and detailed below with reference to FIG. 3B.

Following the initial parse, the protocol stack may determine whether additional parsing is desired or required. As shown at decision block 314, a system and method of incremental parsing may determine whether such additional parsing is requested, for example, by the transport layer of the protocol stack for addressing purposes, by an application program at the destination end device, or by some other hardware or software module. Where no further parsing is required or requested, the data packet may simply be forwarded toward its destination without further processing as shown at block 318.

Responsive to a request for additional parsing, a system and method of incremental parsing may selectively execute one or more additional parsing operations as shown at block 315. An example of such an additional parse was discussed above with reference to header 221 in FIG. 2. In one embodiment, subsequent to execution of additional parsing at block 315, the data packet may be forwarded immediately toward its destination without further processing as shown at block 319. In an alternative embodiment, further data processing may be desirable; in this instance, the protocol stack may again determine whether further parsing is required as illustrated by the loop back to decision block 314.

It will be appreciated that the protocol stack is freed from excessive processing duties by the initial parse. A system and method of incremental parsing initially may determine only whether an incoming packet or message is a complete message in proper format. In accordance with the foregoing embodiments, therefore, parts of the data packet or message may be forwarded without decoding through a parsing operation and subsequent re-encoding.

FIG. 3B is a simplified flow diagram illustrating the general operation of one embodiment of an initial parse. The network communication protocol in the exemplary embodiment of FIG. 3B is SIP; other protocols, though within the scope and contemplation of the invention, have been omitted from the present discussion for clarity. As noted briefly above, when the protocol stack receives a data packet or message transmitted by an endpoint device, firmware or hardware instruction sets or software procedures, for example, may be invoked to execute the initial parse depicted in FIG. 3B.

The initial parse may advantageously be limited to a detailed analysis of only a small portion of the incoming data packet or message. In accordance with SIP, for example, an examination of the data packet start line (such as represented by reference numeral 240 in FIG. 2) may be sufficient to determine whether the message is a properly formed SIP request or response. Headers and content blocks, though they may be identified and separated (blocks 323-328 in FIG. 3B, for example), need not be parsed in detail by the initial parse.

In accordance with the foregoing discussion, the start line of an incoming data packet may be scanned as indicated at block 321. At decision block 322, the format of the start line may be examined such that the nature of the message may be ascertained. If the message is neither a properly formed request nor a properly formed response, the message may be identified as an invalid SIP message at block 390.

For properly formed requests or responses, header information and header values may be extracted at block 323. The iterative nature of this extraction is illustrated by decision blocks 324 and 325. If an invalid header is identified at block 325, the message may be identified as an invalid SIP message at block 390. Where the data packet contains valid headers as determined at block 325, and all the headers and their associated values have been extracted (as determined at block 324), a system and method of incremental parsing may next examine the data packet for content at block 326.

If the data packet does not include content data, the initial parse is complete (block 399). When content data is identified, however, each content line may be extracted in succession (blocks 327 and 328). When all the lines of content data have been extracted as determined at block 328, the initial parse is complete (block 399).

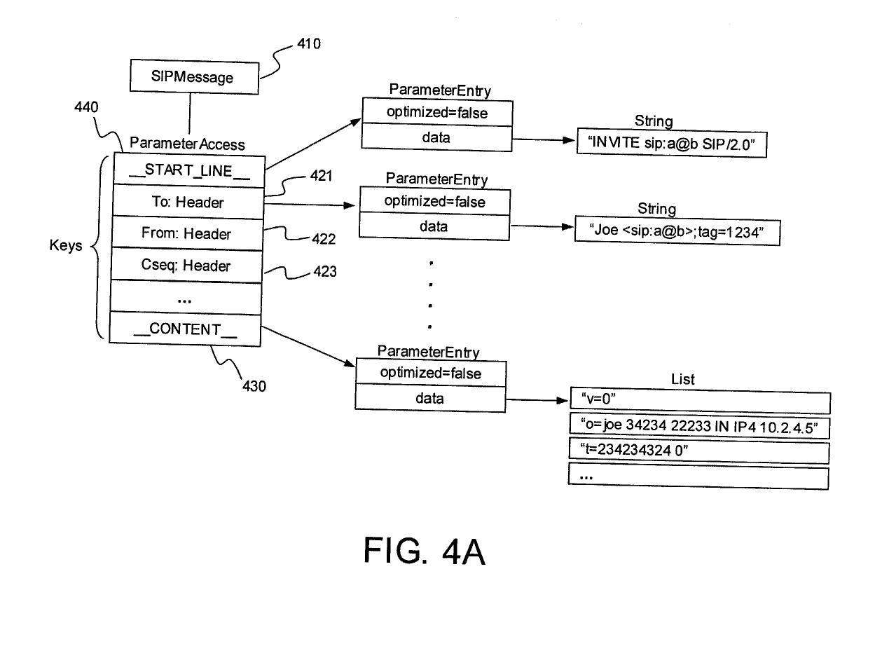

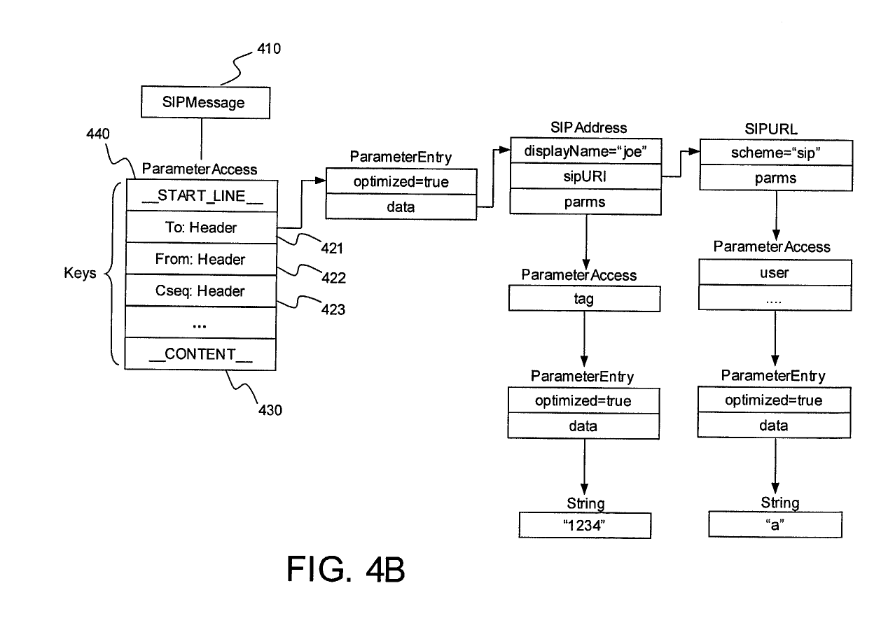

FIG. 4A is a simplified high-level block diagram illustrating one embodiment of the results obtained by an initial parse. At the completion of such an initial parse (depicted at block 399 in FIG. 3B), a SIP message may generally be stored in the exemplary form illustrated in FIG. 4A, wherein special headers and fields are denoted by a key highlighted with underscoring (_); otherwise, the key equals the header name.

The ParameterAccess value may always be a ParameterEntry container having an optimized flag; in this embodiment, the optimized flag may default to “false” to denote that an additional, or second level, parse has not been executed on that field. In one desirable embodiment illustrated on the right side of FIG. 4A, extracted data may generally be maintained in its original string form. Message content data, on the other hand, may be maintained as a list of strings, wherein each string in the list represents a corresponding line of content extracted from the content block of the data packet (as in block 327 of FIG. 3B, for example).

FIG. 4B is a simplified high-level block diagram illustrating one embodiment of the results obtained by an additional parse. For simplicity, only the results of an additional parse of the “To” header 421 are illustrated. The ParameterEntry container of header 421 in FIG. 4B has been optimized (i.e. the optimized flag has been set to “true”), and the data field points to a SIPAddress object rather than to the string shown in FIG. 4A.

By way of example and not by way of limitation, the storage scheme of the SIPAddress object is illustrated in detail, as is the storage scheme of the SIPURL object (contained in SIPAddress). Both may benefit from using ParameterAccess for general purpose storage, and both may be optimized, or fully parsed, as indicated by the respective optimized=true flags in each ParameterEntry container. Depending upon the data requested, the appropriate second level parsing engine may be used to construct an appropriate container class for headers. Such a container class may replace the original string representation for the “To” header 421.

Importantly, all containers (e.g. ParameterAccess and ParameterEntry) may support a toString( ) function which is capable of returning a SIP compliant string representation for use when a parsed or partially parsed data packet is re-encoded for transmission. For example, the ParameterEntry data fields may be either in the form of a string or an optimized container that is required to support toString( ). As illustrated in FIG. 4A, the “_START_LINE_” parameter may simply be copied to the output (since it is the original string data). As shown in FIG. 4B, however, the “To” header 421 may be re-encoded by the SIPAddress class and its contained classes. The “_CONTENT_” list may generally be copied to the output, wherein each list item (string) represents one line of data content from the content block as discussed above.

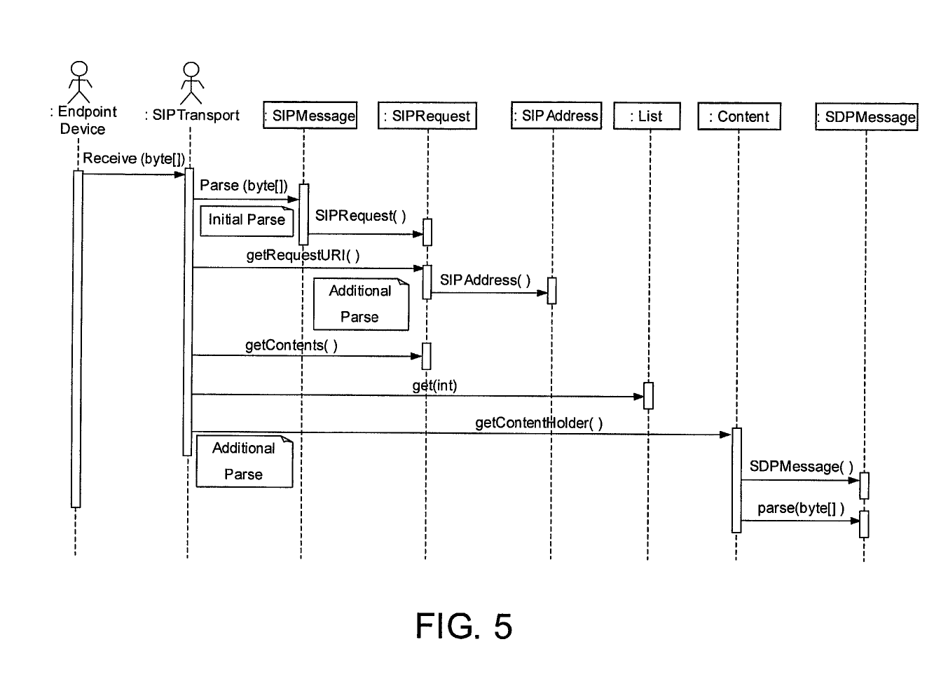

FIG. 5 is a sequence diagram illustrating the general operational flow of one embodiment of a system and method of incremental parsing. Those of skill in the art will appreciate that FIG. 5 utilizes Unified Modeling Language (UML) graphical representations for illustrating interactions between the various objects.

Initially, the SIP transport may receive a data packet or message from an endpoint device and invoke a SIPMessage object. The SIPMessage::parse( ) procedure (i.e. the initial parse) may only parse out the basic message structure as described in detail above with reference to FIGS. 2, 3B, and 4A. The transport may further request that the RequestURI and the Session Description Protocol (SDP) content be parsed also; these additional parsing operations are indicated with notes in FIG. 5. Importantly, a system and method of incremental parsing may not execute additional parsing operations until specifically requested, such as by the SIP transport in FIG. 5.

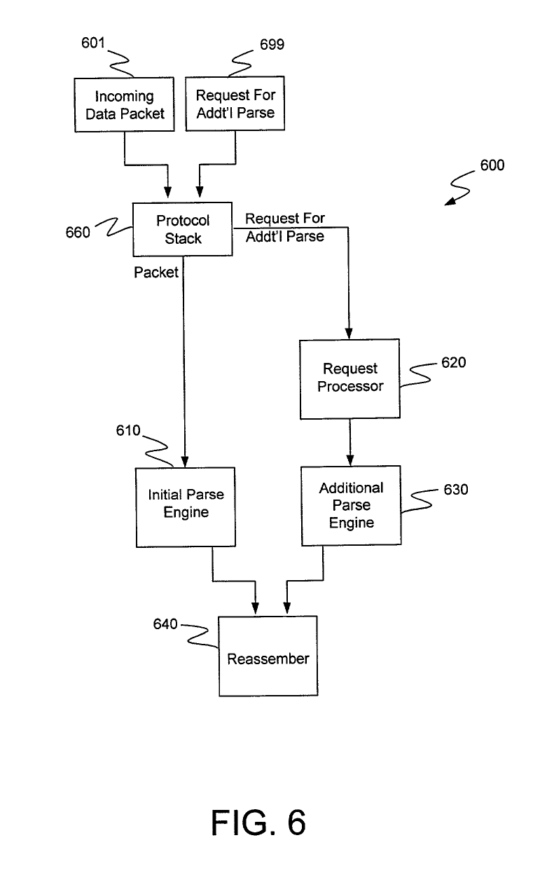

FIG. 6 is a simplified high-level block diagram illustrating one embodiment of a system implementing an incremental parsing strategy. In one embodiment, parsing system 600 may generally be constituted by an initial parse engine 610, a request processor 620, an additional parse engine 630, and a reassembler 640. An incoming data packet 601 is generally received by a protocol stack 660 which, as noted above, may invoke firmware or hardware instruction sets or software code in parsing system 600 to process data packet 601.

Requests for additional parsing, represented by reference numeral 699 in FIG. 6, may also be received by protocol stack 660. Such a request for additional parsing may originate, for example, from firmware or software code residing on a server, proxy, or on the destination endpoint device. Additionally or alternatively, a request for additional parsing may originate within protocol stack 660. For example, the transport layer of protocol stack 660 may require additional parsing of header information for routing purposes.

In the exemplary embodiment, data packet 601 may be routed directly to initial parse engine 610 for initial parsing as described in detail above. Requests for additional parsing may be routed to request processor 620 for analysis. Where additional parsing is requested or required, as determined by request processor 620, data packet 601 may be forwarded to additional parse engine 630 (this forwarding is omitted from FIG. 6 for clarity). Responsive to instructions from request processor 620, additional parse engine 630 may selectively execute an additional parse of one or more specific components of data packet 601.

After parsing, data packet 601 may be reassembled by reassembler 640 In operation, reassembler 640 may identify unparsed components of data packet 601, re-encode components which have been parsed, or decoded, by parse engines 610, 630, and reassemble data packet 601 into a format which is compliant with the communication protocol. In the foregoing manner, reassembler 640 may reconstruct an entire data packet or message from a combination of unparsed packet components and fully parsed packet components. The reassembled data packet 601 may then be forwarded to protocol stack 660 for transmission.

The various components of parsing system 600 may be embodied in hardware or firmware instruction sets, software code, or a combination thereof. In addition, it will be appreciated that the exemplary embodiment of parsing system 600 may be subject to various modifications or alternative implementations. For example, parse engines 610, 630 and request processor 620 may be integrated, such as through a single software program code which enables all of the functionality described above. Alternatively, parse engines 610, 630 may be integrated with reassembler 640 while request processor 620 may be integrated with protocol stack 660.

In an alternative embodiment, all components of parsing system 600 (i.e. parse engines 610, 630, request processor 620, and reassembler 640) may be fully incorporated into protocol stack 660.

Several features and aspects of the present invention have been illustrated and described in detail with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. A method of parsing a data packet; said method comprising:
executing an initial parse of said data packet;
determining whether additional parsing is required; and
responsive to said determining, selectively executing an additional parse.

2. The method of claim 1 further comprising selectively repeating said determining and said selectively executing an additional parse.

3. The method of claim 1 further comprising:
identifying unparsed components of said data packet;
re-encoding parsed components of said data packet; and
reassembling said data packet using results of said identifying and said re-encoding.

4. The method of claim 1 wherein said executing an initial parse includes examining said data packet to ascertain its basic structure.

5. The method of claim 1 wherein said data packet is transmitted in accordance with Session Initiation Protocol (SIP).

6. The method of claim 5 wherein said executing an initial parse includes examining a start line of said data packet.

7. The method of claim 1 wherein said determining includes receiving a request for additional parsing of a specified component of said data packet.

8. The method of claim 7 wherein said executing an additional parse includes parsing said specified component of said data packet in accordance with said receiving.

9. A system for parsing a data packet incrementally; said system comprising:
a first parse engine executing an initial parse of said data packet;
a request processor; and
a second parse engine selectively executing an additional parse of said data packet responsive to instructions from said request processor.

10. The system of claim 9 wherein said first parse engine includes computer executable program code containing instructions for ascertaining the basic structure of said data packet.

11. The system of claim 9 wherein said request processor includes computer executable program code containing instructions for processing requests for additional parsing from components of a protocol stack.

12. The system of claim 9 wherein said request processor includes computer executable program code containing instructions for processing requests for additional parsing from an application program.

13. The system of claim 9 further comprising a reassembler including computer executable instructions for reassembling said data packet using parsed components and unparsed components.

14. The system of claim 9 wherein said first parse engine, said request processor, and said second parse engine are integrated into a protocol stack.

15. A protocol stack for use in a packet-switched data communications network; said protocol stack comprising:
a parser including computer executable program code containing instructions for parsing an incoming data packet incrementally; and
a request processor including computer executable program code for instructing said parser to execute additional parsing.

16. The protocol stack of claim 15 further comprising a reassembler including computer executable program code containing instructions for reassembling said data packet using parsed components and unparsed components.

17. The protocol stack of claim 15 wherein said request processor is responsive to requests for additional parsing from an application program.

18. A computer-readable medium encoded with data and computer executable instructions for parsing a data packet; the data and instructions causing an apparatus executing the instructions to:
execute an initial parse of said data packet;
determine whether additional parsing is required; and
selectively execute an additional parse.

19. The computer-readable medium of claim 18 further encoded with data and instructions, further causing an apparatus selectively to repeat:
determining whether additional parsing is required; and
selectively executing an additional parse.

20. The computer-readable medium of claim 18 further encoded with data and instructions, further causing an apparatus to:
identify unparsed components of said data packet;
re-encode parsed components of said data packet; and
reassemble said data packet using said unparsed components and said parsed components.

21. The computer-readable medium of claim 18 wherein said initial parse includes an examination of said data packet to ascertain its basic structure.

22. The computer-readable medium of claim 18 wherein said data packet is transmitted in accordance with Session Initiation Protocol (SIP).

23. The computer-readable medium of claim 22 wherein said initial parse includes an examination of a start line of said data packet.

24. The computer-readable medium of claim 18 wherein said instructions further cause an apparatus to receive a request for additional parsing of a specified component of said data packet.

25. The computer-readable medium of claim 24 wherein said additional parse includes parsing said specified component of said data packet in accordance with said request.

26. A system for parsing a data packet incrementally; said system comprising:
first parsing means for executing an initial parse of said data packet;
request means for processing a request for additional parsing; and
second parsing means for selectively executing an additional parse of said data packet responsive to instructions from said request means.

27. The system of claim 26 wherein said first parsing means comprises computer executable program code containing instructions for ascertaining the basic structure of said data packet.

28. The system of claim 26 wherein said request means comprises computer executable program code containing instructions for processing requests for additional parsing from components of a protocol stack.

29. The system of claim 26 wherein said request means comprises computer executable program code containing instructions for processing requests for additional parsing from an application program.

30. The system of claim 26 further comprising reassembling means for reassembling said data packet using parsed components of said data packet and unparsed components of said data packet.

31. The system of claim 26 wherein said first parsing means, said request means, and said second parsing means are integrated into a protocol stack.
